(19) United States
(12) Patent Application Publication
(10) Pub. No.: US 2023/0211393 A1
(43) Pub. Date: Jul. 6, 2023

(54) POLYMER WASTE PROCESSING TO YIELD LIQUID PRODUCTS

(71) Applicant: Western Research Institute, Laramie, WY (US)

(72) Inventors: LeAnne V. HAZARD, Laramie, WY (US); Justin L. MARTIN, Laramie, WY (US); Frank D. GUFFEY, Laramie, WY (US)

(73) Assignee: Western Research Institute, Laramie, WY (US)

(21) Appl. No.: 18/150,435

(22) Filed: Jan. 5, 2023

Related U.S. Application Data
(60) Provisional application No. 63/296,569, filed on Jan. 5, 2022.

(51) Int. Cl. B09B 3/40; B09B 3/80

(52) U.S. Cl. CPC B09B 3/40; B09B 3/80; B09B 2101/75

(57) ABSTRACT

In one embodiment, a method for processing polymeric waste materials into one or more products included: pyrolyzing a solid polymeric waste material, wherein the pyrolyzing includes: heating the solid polymeric waste material in the absence of oxygen to a temperature of 725° F. to 850° F. for a duration of 15 to 90 minutes; and thermochemically converting, in response to the heating step, at least some of the solid polymeric waste material into a first liquid product; separating the first liquid product from residual solids; separating a vapor stream from the vessel; and condensing at least a portion of the vapor stream into a second liquid product.

### CROSS-REFERENCE TO RELATED APPLICATIONS

This application claims priority to U.S. Provisional Patent Application Ser. No. 63/296,569, filed Jan. 5, 2022, which is hereby incorporated by reference in its entirety.

### STATEMENT REGARDING FEDERALLY SPONSORED RESEARCH OR DEVELOPMENT

This invention was made with government support under ARPA-E Award No. DE-AR0001360 awarded by the US Department of Energy. The government has certain rights in the invention.

### BACKGROUND OF INVENTION

During the 1960's, plastic debris was discovered in the ocean for the first time, and soon plastics were being recognized as environmental pollutants instead of the idealized material they once were. To address the growing concerns, the United States Environmental Protection Agency (USEPA) began recording statistical information on the generation and disposal of all municipal solid wastes (MSW) in the United States (U.S.), but little was done to affect the growing plastics industry. By the 1980's, environmental awareness was becoming more serious, and so was consumer discontent for discarding so many single-use plastic materials. The population of the U.S. had grown from 180 million residents in 1960 to 227 million residents by the year 1980, and the amount of generated plastics exploded from 0.39 MT (million U.S. tons) to 6.83 MT over the same timeframe, resulting in over 15 times the amount of manufactured plastic being used, and discarded (USEPA 2018). Typically, waste is collected in landfills, which are seen as a solution for countries that have vast amounts of undeveloped land, like the U.S., and are an improvement over non-localized disposal which often used in underdeveloped countries. However, with so much additional waste as a result of single-use packaging, alternative methods to handle the growing accumulation were needed. Combustion with energy recovery, which became unfavorable due to concerns regarding emissions, was redesigned in the 1980's to be more environmentally conscious, and the popularity of the technology grew (USEPA 2019a). The plastics industry also developed a solution for consumers to combat the growing plastics problem, and it was recycling.

### SUMMARY OF THE INVENTION

The present invention relates systems and methods based on pyrolysis (thermal conversion) and hydrocracking (a chemical process that upgrades oils in the presence of hydrogen and often a catalyst) to convert waste, low-value plastic polymers, and paper contaminants into high-energy liquid products suitable as fuel, petrochemical or refinery feedstock, and co-products. Bulk recycled polymers will be processed within a continuous reaction system and will generate lower molecular weight components, while reducing the amount of material that is discarded in landfills. By controlling the specific operating conditions, the pyrolysis technology can produce a liquid product by heating the polymers to a temperature high enough to break the chemical bonds to produce a liquid product. Alternatively, the pyrolysis may also be applied to perform low-level conversion of the polymers which can be combined with a liquid blending agent to yield a suspension of partially deconstructed polymers which may be suitable as a feed for a hydrocracking unit to more efficiently convert the polymers, or as an asphalt additive. This process has been designed to minimize the requirement of manually sorting mixed plastic waste according to polymer type, and will open additional avenues for handling and processing portions of generated waste streams, while reducing the environmental burden of waste plastic materials.

The disclosed systems and methods may process an unsorted mixed plastic waste (MPW) feed, which may include any or all of the following polymers, but shall not be limited to: polyethylene (PE) including high and low density, polypropylene (PP), polystyrene (PS), polyethylene terephthalate (PET), polyvinyl chloride (PVC), polyurethane resins (PUR), and polyester, polyamide, acrylic (PP&A) fibers, and may include any mixture thereof. In some implementations of this invention, a targeted plastic polymer stream may be obtained and processed individually using traditional sorting methods. Plastic polymers may be sourced from oceanic cleaning efforts, consumer recycling programs, material recovery facilities, or other abundant MPW source. The technology has been successful at processing 100% polymers, as well as varying concentrations of polymers in a liquid blending agent from 0-100%, with varying levels of product quality and target markets.

Contamination, which may include but shall not be limited to: newsprint, old corrugated cardboard, mixed recycled paper, boxboard, compostable paper, dirt (nondistinct fines), organics such as food, glass, and metal, of the MPW feed may be tolerated at a preferred level of less than 30 weight percent of the total incoming feed, but is heavily dependent on the amount of paper present.

Liquid blending agents which may be considered include, but are not limited to marine fuels, hydrogen donor oils, and/or low value oils, renewable feedstocks, petroleum or refinery intermediate streams or any mixture thereof. More specifically, marine fuels which may be selected include No. 4, No. 5, or No. 6 fuel oil, or other similar fuels. Hydrogen donor oils which may be selected include synthetic crude oil, fractions of synthetic crude oil, tight oil, shale oil, and/or light crude oils, or similar streams. Low value oils for consideration may include used motor oil, used cooking oil, fluid catalytic cracker oil, or similar low value oils. Bio-oils may be utilized. More preferably, the oil should be comprised of compounds which primarily boil within the range of 520-1050° F.

In one embodiment, a method for processing polymeric waste materials into one or more products comprises: pyrolyzing a solid polymeric waste material, wherein the pyrolyzing comprises: heating the solid polymeric waste material in the absence of oxygen to a temperature of 725° F. to 850° F. for a duration of 15 to 90 minutes; and thermochemically converting, in response to the heating step, at least some of the solid polymeric waste material into a first liquid product; separating the first liquid product from residual solids; separating a vapor stream from the vessel; and condensing at least a portion of the vapor stream into a second liquid product.

In one embodiment, the method comprises, prior to the pyrolyzing step, contacting the solid polymeric waste material with a liquid blending agent to form a mixture.

In one embodiment, the pyrolyzing step comprises: heating the mixture in the absence of oxygen to a temperature of 725° F. to 850° F. for a duration of 15 to 90 minutes; and thermochemically converting, in response to the heating step, at least some of the liquid blending agent and the at least some of the solid polymeric waste material into the first liquid product, separating a vapor stream from the vessel; and condensing at least a portion of the vapor stream into a second liquid product.

In one embodiment, the pyrolyzing step comprises heating the mixture in the absence of oxygen to a temperature of 725° F. to 875° F. In one embodiment, the pyrolyzing step comprises heating the mixture in the absence of oxygen to a temperature of 750° F. to 875° F. In one embodiment, the pyrolyzing step comprises heating the mixture in the absence of oxygen to a temperature of 725° F. to 850° F. In one embodiment, the pyrolyzing step comprises heating the mixture in the absence of oxygen to a temperature of 750° F. to 850° F. In one embodiment, the pyrolyzing step comprises heating the mixture in the absence of oxygen to a temperature of 775° F. to 850° F. In one embodiment, the pyrolyzing step comprises heating the mixture in the absence of oxygen to a temperature of 775° F. to 825° F.

In one embodiment, the pyrolyzing step has a duration of 15 to 90 minutes. In one embodiment, the pyrolyzing step has a duration of 30 to 90 minutes.

In one embodiment, the pyrolyzing step has a duration of 45 to 90 minutes.

In one embodiment, the method comprises contacting the first liquid product with the second liquid product to form a combined liquid product.

In one embodiment, the method comprises separating, prior to the contacting step, the solid polymeric waste material into at least two fractionated polymeric waste streams. In one embodiment, the at least two fractionated polymeric waste streams comprise a low-density polyethylene (LDPE) stream and a polypropylene (PP) stream.

In one embodiment, the liquid blending agent comprises a petroleum or petroleum derived material, a renewable or renewable derived material, marine fuel, a petroleum residue, a hydrogen donor oil, a low value oil, heavy oil, a refinery or petrochemical intermediate stream, solvent, or any combination thereof.

In one embodiment, the solid polymeric waste comprises polyethylene (PE), polypropylene (PP), polystyrene (PS), polyethylene terephthalate (PET), polyvinyl chloride (PVC), polyurethane resins (PUR), polyester, polyamide, acrylic (PP&A) fibers, or any combination thereof.

In one embodiment, at least 50% by weight of the liquid blending agent has a boiling point within the range of 520° F. to 1050° F. In one embodiment, the method comprises preheating the mixture to a temperature of 450 to 925° F. prior to introduction into the thermal conversion reactor.

In one embodiment, the solid polymeric waste material comprises not greater than 30 wt. % non-polymeric material. In one embodiment, the non-polymeric material comprises paper, dirt, organics, glass, foodstuffs, textiles, metal or any combination thereof.

In one embodiment, the paper products comprise newsprint, corrugated cardboard, Kraft paper, mixed paper, boxboard, and/or compostable paper. In one embodiment, the solid polymeric waste material comprises not greater than 30 wt. % paper products.

In one embodiment, the method comprises drying the solid polymeric waste material prior to the blending step. In one embodiment, the solid polymeric waste material comprises not greater than 2.5 wt. % moisture.

In one embodiment, the method comprises mechanically reducing an average particle size of the solid polymeric waste material prior to the blending step. In one embodiment, the average particle size is from 0.25 to 2 inches.

In one embodiment, transferring the mixture to the thermal conversion reactor comprises pumping the mixture to the thermal conversion reactor.

In one embodiment, the method comprises selecting the condensed vapor, the thermally converted liquids, the blended liquid product, or a combination thereof as a hydroprocessing feedstock; transferring the hydroprocessing feedstock to a catalyst bed; contacting the hydroprocessing feedstock with a catalyst of the catalyst bed; and converting the hydroprocessing feedstock into an upgraded liquid product. In one embodiment, the step of contacting the hydroprocessing feedstock with the catalyst occurs at a temperature of 500-950° F. In one embodiment, the hydroprocessing feedstock further comprises an unprocessed liquid blending agent stream.

In one embodiment, the method comprises: transferring the residual solids to a solids storage vessel; collecting an effluent stream from the solids storage vessel into a residual liquid recovery stream; and combining the residual liquid recovery stream with the blended liquid product.

In one embodiment, the method comprises fractionating, separating, and/or recovering the vapor stream from the vessel. In one embodiment, the fractionating, separating, and/or recovering comprises condensing and collecting liquid and solid phase acid products. In one embodiment, the fractionating, separating, and/or recovering comprises separating condensable components from the vapor stream. In one embodiment, the fractionating, separating, and/or recovering comprises separating benzene, toluene, ethylbenzene, and/or xylenes from the vapor stream.

In one embodiment, the fractionating, separating, and/or recovering comprises separating the vapor stream into a condensable fraction and an uncondensable fraction. In one embodiment, the method comprises separating the condensable fraction into simplified fractions. In one embodiment, the method comprises separating the condensable fraction into boiling fractions or compound classes. In one embodiment, the method comprises separating the uncondensable vapor stream into simplified fractions. In one embodiment, the method comprises fractionating the uncondensable vapor stream into an ethylene fraction and/or a propylene fraction.

In one embodiment, the method comprises recycling or recirculating the first liquid product, or fraction thereof, back to the thermal conversion reactor for additional pyrolytic conversion.

In one embodiment, the first liquid product is an asphalt material or additive.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: Is a flowchart illustrating one example process of polymer waste processing to yield liquid products in accordance with the present disclosure.

FIG. 2: Is a flowchart illustrating one embodiment of the Municipal Energy Recovery processing concept in accordance with the present disclosure.

FIG. 3: Is a flowchart illustrating one embodiment of the Sea Plastic Energy Recovery processing concept flow diagram in accordance with the present disclosure.

FIG. 4: shows the resultant boiling point fractions of the pyrolysis product produced via various pyrolysis temperatures from 343 to 454° C. (650-850° F.), with a 60 minute residence time and 10% total polymer loading in a liquid blending agent of fluidized catalytic cracker slurry oil.

FIG. 5: shows the resultant toluene insoluble fraction of the pyrolysis product produced via varying pyrolysis temperatures from 343 to 454° C. (650-850° F.), with a 60 minute residence time and 10% total polymer loading in a liquid blending agent of fluidized catalytic cracker slurry oil.

FIG. 6: shows the resultant qualitative blend compatibility ratings of the pyrolysis product produced via various pyrolysis temperatures from 343 to 454° C. (650-850° F.), with a 60 minute residence time and 10% total polymer loading in a liquid blending agent of fluidized catalytic cracker slurry oil.

FIG. 7: shows the resultant boiling point fractions of the pyrolysis product produced via various pyrolysis temperatures from 343 to 454° C. (650-850° F.), with a 60 minute residence time and 10% total polymer loading in a liquid blending agent of hydrocracker feedstock.

FIG. 8: shows the resultant toluene insoluble fractions of the pyrolysis product produced via various pyrolysis temperatures from 343 to 454° C. (650-850° F.), with a 60 minute residence time and 10% total polymer loading in a liquid blending agent of hydrocracker feedstock.

FIG. 9: shows the resultant qualitative blend compatibility ratings of the pyrolysis product produced via various pyrolysis temperatures from 343 to 454° C. (650-850° F.), with a 60 minute residence time and 10% total polymer loading in a liquid blending agent of hydrocracker feedstock.

FIG. 10: shows the resultant the toluene insoluble fractions of the pyrolysis product produced via various pyrolysis residence time (0-90 minutes) and pyrolysis temperatures from 413 and 427° C. (775 and 800° F.) with a 65% total polymer loading in a liquid blending agent of hydrocracker feedstock.

FIG. 11: shows the resultant boiling point fractions of the pyrolysis product produced via various pyrolysis temperatures from 427 to 454° C. (800-850° F.), with a 45 minute residence time and 65% total polymer loading in a liquid blending agent of hydrocracker feedstock.

FIG. 12: shows the resultant toluene insoluble fractions of the pyrolysis product produced via various pyrolysis temperatures from 427 to 454° C. (800-850° F.), with a 45 minute residence time and 65% total polymer loading in a liquid blending agent of hydrocracker feedstock.

FIG. 13: shows the resultant qualitative blend compatibility ratings of the pyrolysis product produced via various pyrolysis temperatures from 427 to 454° C. (800-850° F.), with a 45 minute residence time and 65% total polymer loading in a liquid blending agent of hydrocracker feedstock.

FIG. 14: shows the resultant toluene insoluble fractions of the pyrolysis product produced via various pyrolysis temperatures from 371 to 400° C. (700-750° F.), with a 60 minute residence time and 10% total polymer loading in a liquid blending agent of renewable oil.

FIG. 15: shows the resultant qualitative blend compatibility ratings of the pyrolysis product produced via various pyrolysis temperatures from 371 to 400° C. (700-750° F.), with a 60 minute residence time and 10% total polymer loading in a liquid blending agent of renewable oil.

FIG. 16: shows the resultant toluene insoluble fractions of the pyrolysis product produced via various pyrolysis residence times from 60-90 minutes, with a 400° C. (750° F.) temperature and 30% total polymer loading in a liquid blending agent of renewable oil.

FIG. 17: shows the resultant qualitative blend compatibility ratings of the pyrolysis product produced via various pyrolysis residence times from 60-90 minutes, with a 400° C. (750° F.) temperature and 30% total polymer loading in a liquid blending agent of renewable oil.

FIG. 18: shows the resultant toluene insoluble fractions of the pyrolysis product produced via various pyrolysis temperatures from 399 to 454° C. (750-850° F.), with a 60 minute residence time and 100% total polymer loading.

FIG. 19: shows the qualitative blend compatibility ratings of the pyrolysis product produced via various pyrolysis temperatures from 399 to 454° C. (750-850° F.), with a 60 minute residence time and 100% total polymer loading.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

As used herein, the term “pyrolysis” means a process in which a feedstock is subjected to elevated temperatures, and near-ambient pressures, to initiate free radicals in either the gas or liquid phase. Free radicals are highly reactive species as a result of an unpaired valence electron, and may be reactive towards other molecules, or themselves. In an effort to become stable, the free radical molecule can follow a variety of reaction pathways. Depending on the volatility of the stable product molecule, the product may either report to the overhead fraction, or remain within the liquid reaction media where additional pyrolysis reactions may continue.

As used herein, the term “solid polymeric waste material” means discarded material that comprises at least 50% by weight of polymer or plastic. Solid polymeric waste material may also include some amount of other types of waste including paper products, metal, food, etc.

As used herein, the term “co-processing” means the act of processing something with or at the same time as something else.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

### EXAMPLE 1

The liquid blending agent will be stored in a vessel at a temperature of between ambient and 600° F. The liquid blending agent will be transferred via pump, and optional preheater to the MPW/liquid blending agent mixing and preheat vessel. The MPW will enter a size reduction step, which will entail shredding/grinding/pulverizing the MPW into particles which can enter the MPW/liquid blending agent mixing and preheat vessel. An optional storage/drying unit can be used if the water content of the incoming MPW is greater than 5 weight percent. The MPW and liquid blending agent enter the mixing and preheat vessel, preferably stirred, and operated at a temperature between 150-925° F., and residence time greater than 15 minutes.

The mixed and preheated liquid blending agent and MPW stream will then be pumped to an optional preheater, before entering the thermal conversion (pyrolysis) reactor. The thermal conversion unit will operate within a temperature range between 725-850° F., and a residence time of between 15 minutes and 90 minutes. There will be two product streams from the thermal conversion reactor, with the first being the bottoms product. The bottoms product will contain heavy molecular weight products, in addition to coke/char, metals, dirt, and other contaminants. The bottoms product will be pumped to a heat exchanger to reduce the temperature of the stream, before the material is transferred to the solids/liquid separation vessel. The solids/liquid separator will recover the desirable liquid product at a temperature between 100-400° F., and a residence time from 0-8 hours depending on separation technique selected. The recovered desirable liquid product will be transferred to the final product storage, or may be stored separately for use as an asphalt additive. The recovered solids will be transferred to a storage vessel, which will likely maintain a temperature between ambient and 250° F. If desirable, a second stage liquid recovery unit can be utilized to enhance desirable liquid product recovery.

The overhead product from the thermal conversion reactor will contain lower molecular weight condensable and uncondensable products. The overhead product may enter the optional first stage condenser, where solid acids (terephthalic) may be recovered. The residual overhead may then pass to an alkaline scrubbing unit, which can be utilized to neutralize any produced condensable acids. The residual overhead may then pass to a second stage condenser, before being transferred to the overhead storage vessel, which is anticipated to be maintained at temperature of less than 100° F. The condensable fraction may be fractionated to recover valuable products (e.g. benzene, toluene, ethylbenzene, or xylenes). The uncondensable overhead product (off gas) may be utilized as fuel gas, sweep gas, fractionated to recover valuable products (e.g. ethylene or propylene), or flared. Optionally, water (produced or inherent) may be recovered from the overhead storage vessel. The liquid residual overhead product may either be mixed with the bottoms product either ahead of the solids/liquid separator or after the solids/liquid separator before entering the final blended product vessel which will maintain a temperature of less than 250° F.

Optionally, a hydroprocessing step may be employed to the collected overhead product, the recovered bottoms product, the blended product, or any combination therein. The streams being fed to the optional hydroprocessing step can be mixed in-line ahead of a pump and preheated ahead of the hydroprocessing catalyst bed. The catalyst processing step may be comprised of one, or many catalysts in series, which can be operated at pressures between 0-3000 psig, temperatures between 500-950° F., and LHSV 0-5.

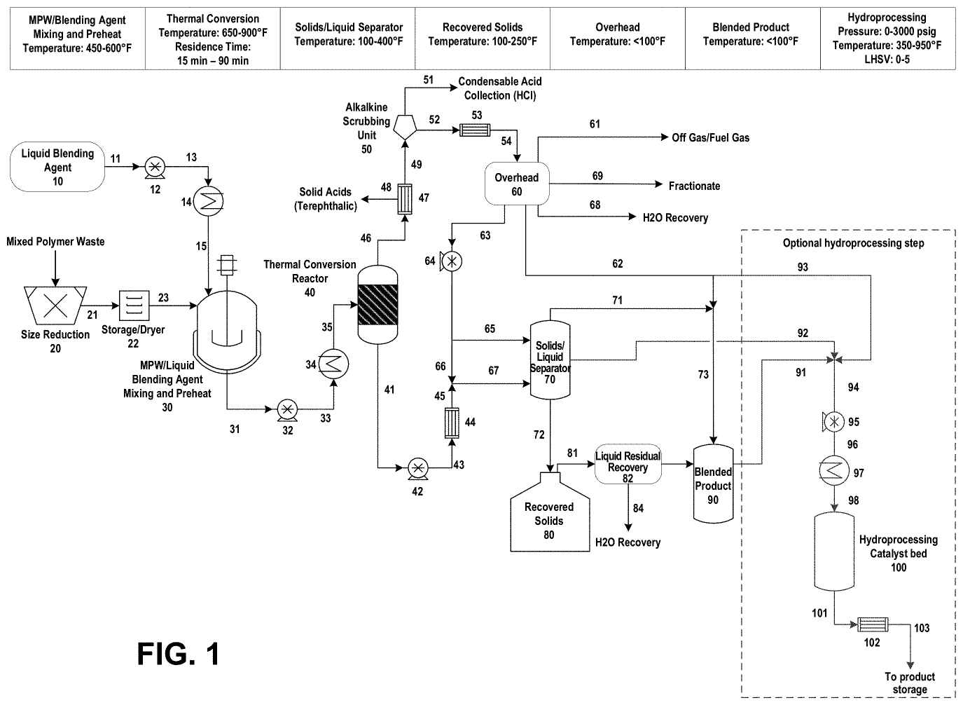

Turning now to FIG. 1, the illustrated embodiment includes the following components:
10 Liquid Blending Agent
   11 Liquid blending agent transfer line to pump
   12 Liquid blending agent pump
   13 Liquid blending agent transfer line to preheater (if necessary)
   14 Liquid blending agent preheater (if necessary)
   15 Heated liquid blending agent transfer line to MPW/Liquid Blending Agent mixing and preheat vessel
20 Mixed Polymer Waste size reduction
   21 Reduced sized MPW transfer line to optional storage/drying unit
   22 Optional 1VIPW storage/drying unit
   23 Optional MPW storage/drying unit transfer line to MPW/Liquid Blending Agent mixing and preheat vessel
30 MPW/Liquid Blending Agent mixing and preheat vessel
   31 Heated 1VIPW/Liquid Blending Agent transfer line to pump
   32 Heated MPW/Liquid Blending Agent pump
   33 Heated MPW/Liquid Blending Agent transfer line to preheater
   34 Heated MPW/Liquid Blending Agent preheater
   35 Heated MPW/Liquid Blending Agent transfer line from preheater to reactor
40 Thermal Conversion (pyrolysis) reactor
   41 Produced bottoms fraction transfer line to pump
   42 Produced bottoms pump
   43 Produced bottoms transfer line to heat exchanger
   44 Produced bottoms heat exchanger
   45 Cooled bottoms transfer line to mixing tee with optional overhead stream
   46 Produced overhead and gas transfer line to stage 1 condenser
   47 Produced overhead and gas stage 1 condenser
   48 Solid acid recovery
   49 Residual overhead and gas transfer line from stage 1 condenser to alkaline scrubbing unit
50 Alkaline Scrubbing unit
   51 Liquid acid recovery
   52 Residual overhead and gas transfer line from alkaline scrubbing unit to stage 2 condenser
   53 Residual overhead and gas stage 2 condenser
   54 Residual overhead and gas transfer line from stage 2 condenser to overhead collection vessel
60 Overhead collection vessel
   61 Off gas/Fuel gas
   62 Collected overhead transfer line to final blended product mixing tee
   63 Optional collected overhead transfer line to overhead pump
   64 Optional collected overhead pump
   65 Optional collected overhead transfer line to solids/oil separator
   66 Optional collected overhead transfer line to produced bottoms mixing tee
   67 Bottoms and optional collected overhead transfer line to solids/oil separator
   68 Optional water recovery transfer line
   69 Optional fractionate (e.g. benzene, toluene, ethylbenzene, xylenes, ethylene, propylene)
70 Solids/Liquid Separator
   71 Recovered liquid transfer line to final blended product mixing tee, or bottoms product storage
   72 Recovered solids transfer line to recovered solids storage
   73 Collected overhead and recovered liquid product from solids/liquid separator transfer line to blended product storage
80 Recovered solids storage
   81 Optional transfer line for optional stage 2 liquid recovery
   82 Optional stage 2 liquid recovery
   83 Optional stage 2 liquid recovery transfer line to blended product storage
   84 Optional water recovery transfer line
90 Final blended product storage
   91 Optional transfer line of blended product to hydroprocessing step
   92 Optional transfer line of recovered liquid from solids/liquid separator to hydroprocessing step
   93 Optional transfer line of collected overhead to hydroprocessing step
   94 Optional transfer line from mixing tee of products transferred to hydroprocessing step
   95 Optional hydroprocessing feed pump
   96 Optional hydroprocessing transfer line to preheater
   97 Optional hydroprocessing feed preheater
   98 Optional preheated feed transfer line to hydroprocessing catalyst bed
100 Optional hydroprocessing catalyst bed (may add additional in series if necessary)
   101 Optional hydroprocessed product transfer line to condenser
   102 Optional hydroprocessed product condenser
   103 Optional hydroprocessed product transfer line to hydroprocessed product storage.

### EXAMPLE 2

The feedstock may require some initial pre-processing, which may include the removal of non-organic components, including glass, as well as ferrous and nonferrous metals. Recovering the inorganic materials instead of subjecting them to the processing is beneficial because it is less intensive to recover already refined metals and glass instead of sourcing, recovering, and processing raw ores. With only minor pre-processing of the polymer feedstock, the cost of sorting is expected to remain low. The process cannot guarantee a complete removal of non-organic components, and is intended to handle some level of contamination, up to 30 weight percent of incoming feed. Likely contaminants may include, but are not limited to:

polyvinyl chloride, mixed papers, cardboard, compostable paper, food, dirt, and trace amounts of glass and metals.

The polymer feedstock material may include, but is not limited to: plastic polymers which may include polyethylene (PE) including high and low density, polypropylene (PP), polystyrene (PS). In some embodiments, other plastic polymers can be processed via the disclosed systems and methods. Suitable liquid blending agents may include, but are not limited to, low value oils such as petroleum oils (fluid catalytic cracker oil, hydrocracking feedstocks) or bio-oils (such as used cooking oil), or other similar low value streams.

In one embodiment, the process is a batch process. In one embodiment, the process is a continuous process. The process relies on a thermal conversion step to thermally decompose the polymers in the presence of a liquid blending agent. The process may first subject the polymers to a size reduction step, before the reduced size polymers are combined with a selected liquid blending agent and preheated to obtain a mixed, semi-uniform feed stream. The feed stream will supply a thermal conversion unit. The thermal conversion unit will generate a marketable liquid hydrocarbon stream, composed of lower molecular weight products and resulting co-products via free radical pyrolysis reaction pathways. Compounds which are volatile under the selected operating conditions will exit the thermal conversion unit as the overhead fraction. Non-volatile compounds will exit the thermal conversion unit as the bottoms fraction, which may require further separation to remove solids from the valuable liquid phase. The solids fraction may be comprised of solids, char (coke), or unreacted polymers, which may be undesirable in the intended final product, but may be utilized for process heat, or potentially marketed. The recovered liquid from the bottoms fraction may be blended with the overhead fraction from the thermal conversion step, and marketed, or may be fed directly to a hydrocracker processing unit, or similar, for further upgrading. Based on the characteristics of the feedstock polymers, and selected processing conditions, the produced liquid hydrocarbon stream may be utilized as a feedstock for the petrochemical, refinery, or asphalt industry.

Thermal conversion operating conditions may be established at polymer loadings between 0 and at least 75 percent by weight, and temperatures between 725 and 850° F., and may require residence times between 15 and 90 minutes. Specific operating conditions may be selected according to the specific feedstock characteristics, and desired product slate.

More preferably, the thermal conversion operating conditions may be established at polymer loadings between 50 and 100 percent by weight, temperatures between 725 and 850° F., and residence times of less than 60 minutes to generate a blend stock.

More preferably, the thermal conversion operating conditions may be established at polymer loadings between 30 and 75 percent by weight, ambient pressure, temperature between 725 and 850° F., and residence time of less than 90 minutes to generate a potential asphalt additive.

### EXAMPLE 3

### Municipal Energy Recovery (MER) of Municipal Solid Wastes (MSW)

One prior art application of pyrolysis, which is known to those familiar in the art as “fast pyrolysis”, may involve introducing reduced size MSW, suspended in a turbulent carrier gas stream, to elevated temperatures at short residence times.

Components in the prior art reaction are held at temperature for approximately 10 seconds, before the material is rapidly cooled in an effort to maximize the amount of liquid yield, while minimizing the amount of harmful free radical termination reactions. Termination reactions are undesirable because they may produce compounds of high molecular weight which may be precursors to char (coke). Using a high reaction temperature followed by a rapid cooling is very energy-intensive, and may not be suitable for industrial purposes. It may beneficial to include a liquid blending agent when designing an environment for pyrolysis based reactions, instead of processing in an environment composed of only polymers. The use of a liquid blending agent can enhance heat transfer capabilities, thus allowing for better thermal control which will aid in minimizing the amount of char (coke) and gas produced. The liquid blending agent may help reduce the amount of recombination by reactive products, which may be char (coke) precursors.

By treating the MSW feedstock as a whole, rather than fractioning MSW into individual components, the MER processing may minimize the requirement and cost for manual sorting. MER will also alleviate the burden on the environment by reducing the amount of MSW material that will require landfill as a final destination.

Bulk MSW will likely require some initial pre-processing steps, which may include the removal of non-organic components, including glass, as well as ferrous and nonferrous metals. Recovering these inorganic materials instead of subjecting them to the MER processing concept is beneficial because it is less energy intensive to recover already refined metals and glass instead of sourcing, recovering, and processing raw ores. With only minor pre-processing of the MSW, the cost of sorting is expected to remain low. The remaining MSW material destined for the MER processing concept may include, but is not limited to: paper and paperboard, plastics, wood, food, yard trimmings, trace amounts of contaminants, including soil, or mixtures thereof. In some embodiments, MSW may be further sorted using traditional methods to obtain simplified fractions of MSW as a feedstock. Liquid blending agents which may be considered include, but are not limited to hydrogen donor oils and/or low value oils, or any mixture thereof. More specifically, hydrogen donor oils which may be selected include synthetic crude oil, fractions of synthetic crude oil, tight oil, shale oil, and/or light crude oils, or similar streams. Low value oils for consideration may include used motor oil, used cooking oil, fluid catalytic cracker oil, or similar low value streams.

The illustrated MER embodiment is designed to be a continuous, pyrolysis-based process to thermally upgrade MSW in the presence of a liquid blending agent, comprised of an oil medium. The illustrated embodiment comprises a tank to combine reduced size MSW with a selected oil medium to obtain a mixed, semi-uniform feed stream. The blended feed may supply a thermal conversion unit, which will generate a marketable liquid hydrocarbon stream composed of lower molecular weight products and resulting co-products via free radical pyrolysis reaction pathways. Based on the characteristics of feedstock MSW and the oil medium selected for the MER processing concept, the produced liquid hydrocarbon stream may be utilized as a feedstock for the petrochemical or refinery industry.

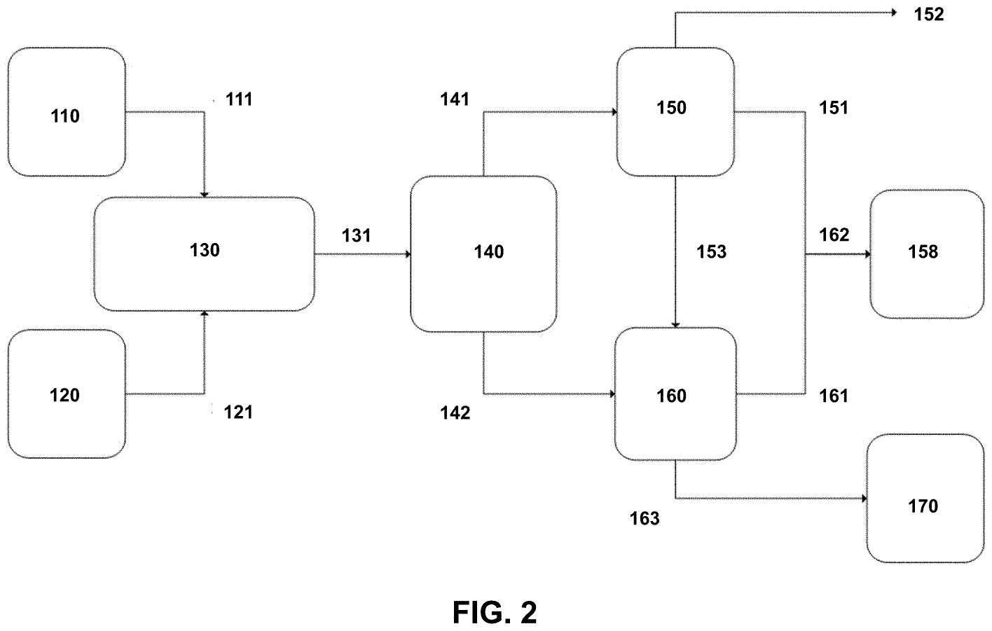

Turning now to FIG. 2, one example of an MSW process is shown. The illustrated MSW processing embodiment may require some pre-processing to remove inorganic material, including glass, ferrous, and nonferrous metals. Pre-processing may be done on-site using appropriate methods, or may exploit existing sorting capabilities at other locations. Pre-processed MSW is introduced to a size reduction unit, 120, which may take the form of a grinder, shredder, chipper, or any other established size reduction unit which is capable of reducing the size of bulk materials to achieve a proper size distribution of less than five inches. Reduced size MSW will likely require some drying to reduce the moisture content of the incoming feed, and a temporary storage vessel, which may take the form of a hopper, bin, or silo, designed such that channel flow has been eliminated. More preferably, the temporary storage vessel may be configured with a star valve or equivalent to mitigate vapor loss upon transfer, stream 121, of the MSW to a mixing tank, 130. Selected oil media is stored in a tank, 110, before being transferred continually, stream 111, into the mixing tank, 130.

The combined oil media and reduced sized MSW material may be mixed, 130, until a suspension, slurry, solution, or similar is formed. More specifically the ratio of oil medium material to MSW may not be critical, but a range from about 2:1 to 20:1 oil to MSW may be sufficient to create a semi-uniform feed stream, at a temperature between 450 to 925° F. After the oil media and MSW have been sufficiently combined, 130, the material will be diverted, stream 131, to a thermal conversion unit, 140. The thermal conversion unit, 140, shall establish pyrolytic conditions to generate lower molecular weight components from the feedstock MSW and oil medium. Pyrolytic operating conditions may be established at, temperatures between 725 and 850° F., and may require residence times between 15 and 90 minutes. Specific operating conditions may be selected according to the specific MSW feedstock characteristics.

Compounds which are volatile under the selected operating conditions exit the thermal conversion unit, 140, as the overhead fraction, stream 141. Recovery of the overhead fraction, stream 141, will require a temperature reduction to condense the material into a liquid or solid phase, and may require a multiple stage recovery system. Singular or multiple condensing units may be required, and may take the form of standard tube and shell, cyclone, or any other suitable heat exchanger design. Uncondensable overhead vapor, stream 152, which may include hazardous or environmentally restricted vapors, may require additional scrubbing using established methods before utilization as fuel gas, flared, or vented to atmosphere. Condensed and scrubbed overhead liquid material is then stored in the overhead collection vessel, 150. Notably, the condensed overhead fraction may be buffered and stored at near-ambient conditions, until further processing is required, or the material is added into the final blended product, stream 151.

Compounds which are not volatile under the selected operating conditions exit the thermal conversion unit, 140, as the bottom fraction, stream 142. A traditional heat transfer unit may be required to reduce the temperature of the bottoms fraction, stream 142, as it enters the liquid-solid separation unit, 160. Phase separation units for consideration may include a settling tank, cyclone, or other similar unit which has been designed to separate materials based on physical properties. Settling time may vary significantly, depending on the type of processing vessel selected, and feedstock MSW characteristics. In some embodiments, the condensed overhead fraction, stream 153, may be introduced to the bottoms fraction in the liquid-solid separation unit, 160, to enhance the separation of physical phases and the recovery of the liquid fraction, stream 161.

Recovered solids may be transferred, stream 163, to a recovered solids tank, 170, and may be comprised of soil, char (coke), or any additional unreacted MSW components including inert, or inorganic materials, all of which are undesirable in the intended final blended product. The recovered solids tank, 170, may require temperatures between ambient and 250° F. Although recovered solids are undesirable in the intended final blended product of the MER process, the solids may serve as a potential combustion source, or be applicable in other industrial areas.

Recovered liquid, stream 161, from the solid-liquid separator, 160, will be combined in-line with condensed overhead, stream 151, to reduce the viscosity of the resultant stream, stream 162, which is the final blended product. The final blended product may be stored, 180, at a stable condition, or may be distributed directly to market. Stability of the final blended product is ideally achieved at temperatures below 250° F. The final blended product is intended as a petrochemical or refinery feedstock, and is value added because of the incorporated lower molecular weight components generated during the thermal conversion.

Additionally, a water recovery and treatment unit may be required to extract and eliminate water soluble organic material. Water may be formed during thermal conversion, 140, of materials from the MSW feedstock which contain oxygen, and may become entrained with streams later in the process. It may be desirable to reduce the moisture content of the MSW feedstock to less than 10 percent, after size reduction, 110, as to limit the amount of water that may enter the MER process. This can reduce the capacity of water that must be separated and recovered in later stages of the MER processing concept.

In one embodiment of the MER process, a feed stream composed of only the mixed plastic waste fraction of the bulk MSW feedstock may be utilized. The mixed plastic waste fraction may be comprised of, but not limited to, PE, PP, PS, PET, PVC, and trace impurities, less than one percent, such as paper labels, residual food, or soil. The waste plastics will be reduced to a particle size of less than five inches by mechanical size reduction. The plastic particles will be subjected to drying during the storage phase. Dried and reduced size plastic particles may be fed continuously to a mixing tank, and combined with a selected oil medium to obtain a semi-uniform feed stream for the thermal conversion unit. In the thermal conversion unit, the feed stream may undergo pyrolysis to initiate thermal degradation to yield lower molecular weight liquid products, along with resulting char (coke) and gas streams. Produced overhead and bottoms fractions may be combined in production ratios to obtain a marketable feedstock for the petrochemical or refining industry. Additional co-products from this reaction may be recovered from the overhead stream, and may include: hydrochloric, benzoic, and terephthalic acids which may be further processed to pure forms and sold. Characteristics of the final liquid hydrocarbon product may vary according to the incoming distribution of plastic polymers in the feedstock MSW.

Bridgewater, A.V., 2012, “Review of Fast Pyrolysis of Biomass and Product Upgrading”, Biomass and Bioenergy, 38, pp 68-94

Geyer, R., J. R. Jambeck, K. L. Law, 2017, “Production, Use and Fate of all Plastics Ever Made”, Sci. Adv. 2017, 19 Jul. 2017.

Guffey, F. D. and F. A Barbour, 1992, “Recycling Waste Plastics by Thermal Decomposition”, Western Research Institute Report of Investigations, WRI-92-M008, Laramie, Wyo.

Hoornweg, D., P. Bhada-Tata, C. Kennedy, 2013, “Environment: Waste Production Must Peak this Century”, Nature, 502, 615-617.

US Environmental Protection Agency, 2017, Sustainable Materials Management: Non-Hazardous Materials and Waste Management Hierarchy.

US Environmental Protection Agency, 2018a, Reducing the Impact of Wasted Food by Feeding the Soil and Composting.

US Environmental Protection Agency, 2018b, Municipal Solid Waste Landfills.

US Environmental Protection Agency, 2018c, Advancing Sustainable Materials Management: 2015 Fact Sheet, EPA Report No. 530-F-18-004.

US Environmental Protection Agency, 2019, Energy Recovery from the Combustion of Municipal Solid Waste (MSW).

Savage, Phillip E., 2000, “Mechanisms and Kinetics Models for Hydrocarbon Pyrolysis”, Journal of Analytical and Applied Pyrolysis, 54 pp. 109-126.

Waste360 Staff, 2019, “Report: U.S. Sent 157,000 Shipping Containers of Plastic Waste to Other Countries in 2018.” Waste360, 12 Mar. 2019.

### EXAMPLE 4

### Sea Plastic Energy Recovery (SPER) of Oceanic Mixed Plastic Waste

As a result of so much plastic debris in the ocean, aquatic life, including sea birds, are often unable to distinguish between plastic debris and actual sources of food. Upon ingestion of MPW, animals may be unable to expel the plastic, leading to reduced appetite, or obstruction of the digestive system. This can significantly diminish wellbeing, and may ultimately lead to death. The human species is also at risk of exposure to microplastics, which can become entrained with the vapor during the natural evaporation process of seawater from the ocean. Trapped microplastics can then be transported from the ocean to other regions of the world through changing weather patterns. Environmental pollution of plastics is recognized as a problem, yet the full extent of the global impact of plastic is currently unknown, and is an ongoing research opportunity.

The SPER processing concept has been designed such that the process will help alleviate the burden on the environment by transforming MPW pollutants into an energy source. MPW shall be acquired, and may in some cases utilize a company tasked with scavenging plastics from the ocean, and shall be transferred to the processing facility. MPW destined for the SPER processing concept may be comprised of an indiscriminate size, and may include discarded consumer plastics, fishing nets, microplastic fragments, or other discarded plastic composed of any polymer type. SPER is intended to be robust, and is designed to process an unsorted MPW feed, which may include any or all of the following polymers, but shall not be limited to: polyethylene (PE) including high and low density, polypropylene (PP), polystyrene (PS), polyethylene terephthalate (PET), polyvinyl chloride (PVC), polyurethane resins (PUR), and polyester, polyamide, acrylic (PP&A) fibers, and may include any mixture thereof. In some implementations of this invention, a pure polymer stream may be obtained and processed individually using traditional sorting methods. Liquid blending agents which may be considered include, but are not limited to marine fuels, hydrogen donor oils, and/or low value oils, or any mixture thereof. More specifically, marine fuels which may be selected include No. 4, No. 5, or No. 6 fuel oil, or other similar fuels. Hydrogen donor oils which may be selected include synthetic crude oil, fractions of synthetic crude oil, tight oil, shale oil, and/or light crude oils, or similar streams. Low value oils for consideration may include used motor oil, used cooking oil, fluid catalytic cracker oil, or similar low value oils.

The SPER process is designed to be a continuous, pyrolysis-based process which will thermally upgrade MPW in the presence of an oil medium liquid blending agent. MPW will require some preparation, in the form of size reduction to enhance heat transfer and drying to remove seawater from the feedstock. The prepared MPW fragments will be blended with a liquid blending agent in the form of an oil medium to form a mixed, semi-uniform feed stream. A thermal conversion unit will upgrade the blended feed via free radical pyrolysis reaction pathways to generate a low sulfur liquid hydrocarbon marine fuel comprising lower molecular weight components, and shall also produce a variety of co-products. According to the MPW variability and selected oil medium, the produced liquid hydrocarbon product from the SPER processing concept may be utilized as a fuel for the marine industry because of the inherent low sulfur content.

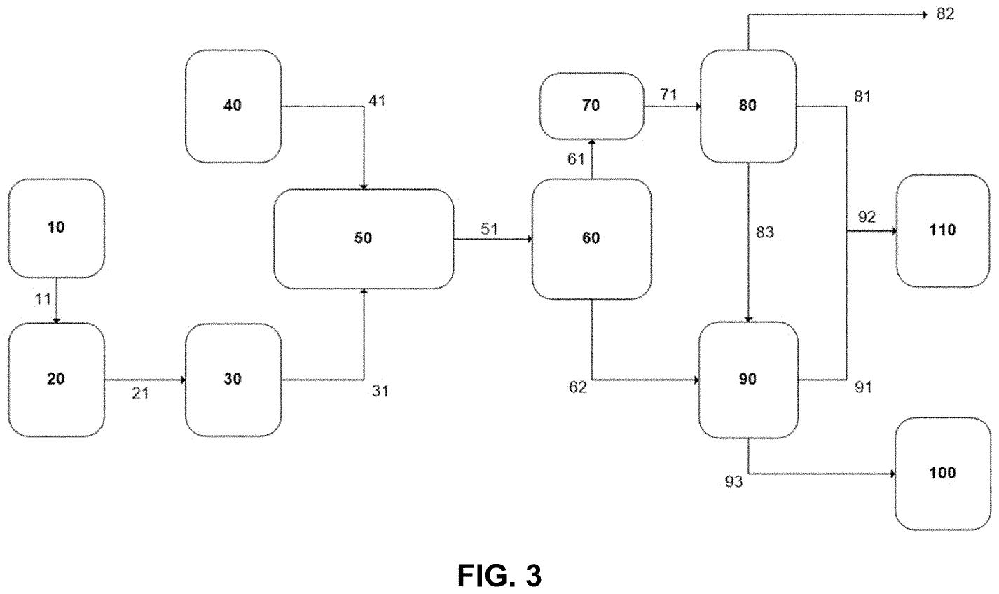

SPER is a processing concept which thermally converts synthetic organic polymers in recovered MPW from an undesirable environmental pollutant to a low sulfur marine fuel, and resulting co-products. SPER will reduce the quantity of MPW in the ocean, and thus the environmental strain on the aquatic ecosystem. The processing concept will also alleviate transportation requirements of negative value MPW, while producing a low sulfur value-added marine fuel. FIG. 3 includes related processing equipment required for efficient operation of the SPER process; however, the process is not limited to, or restricted from additional processing equipment based on a requirement to operate safely, more efficiently, minimize environmental impact, or on a continuous basis.

Although the invention is herein described as a mobile processing facility, the concept is not limited from being applied to a static platform, or coastal facility where space is less restricted. In accordance with maritime design requirements, the processing equipment may be located on a marine vessel. SPER was designed to process MPW from the ocean, but shall not be limited from accepting MPW from land-based facilities if applicable. SPER is intended to acquire MPW from a company tasked with environmental remediation, but other iterations of the present design may be modified to include a MPW collection system. Low sulfur marine fuel may be generated for the marine vessel facility directly from the described process, and may reduce or eliminate the requirement of refueling and time in port.

MPW will be acquired and transferred directly to the SPER processing facility. Onloaded MPW will likely contain excess seawater, which shall be reduced before additional processing. As shown in FIG. 3, initial MPW preparation may include a non-intensive drying phase, 10, which is intended to reduce the amount of seawater entering the size reduction unit, 20, without expending so much energy as to completely dry all of the seawater from the MPW. The preparation step shall also be used to mitigate daily fluctuations in MPW acquisition, and serve as a buffer to maintain continuous operation. Water reduction units, 10, for consideration may involve a tumbler, agitator, or high-residence time conveyer with subsequent buffer storage in a hopper, bin, or silo. Prepared MPW is then transferred, stream 11, from drying and buffer storage, 10, to a size reduction unit, 20, at a rate sufficient to operate continually without exhausting buffer reserves. Prepared MPW and residual seawater may be subjected to a grinder, shredder, chipper, or other established size reduction method, 20, capable of reducing the size of bulk materials to a preferred particle size of less than five inches. Reduced size MPW, stream 21, may then enter a more sophisticated drying and storage step, 30, to reduce the water content to less five percent, and may take the form of a heated conveyer, hopper, bin, or silo, designed such that channel flow has been eliminated. More preferably, the storage tank, 30, may be equipped with a rotary lock valve or equivalent to mitigate vapor loss during the transfer of dried and reduced size MPW, stream 31, to the blending tank, 50. Oil media selected for SPER process will be obtained, and subsequently stored in a holding tank, 40, at a temperature less than 300° F. before continuous transfer, stream 41, into the mixing tank, 50.

Dried and reduced size MPW will be mixed, 50, with the oil medium until a suspension, slurry, solution, or similar is formed. The addition of reduced sized MPW shall occur at a rate sufficient to maintain buffer reserves, without depriving the process of MPW feed, and shall be adjusted accordingly. More specifically, to maintain a semi-uniform feed stream, conditions may be established within the temperature range of 450 and 925° F. and may require a residence time anywhere from 15 minutes to four hours. Even more specifically, the ratio of oil medium material to MPW may not be critical, but a range from about 2:1 to 20:1 oil to MPW may be sufficient to obtain a semi-uniform feed stream. After the oil media and MPW have been suitably combined, 50, the material will be diverted, stream 51, to a thermal conversion unit, 60. Pyrolytic conditions shall be established in the thermal conversion unit, 60, such that lower molecular weight components may be generated from the feedstock MPW and oil medium. Conditions suitable for thermal conversion of MPW may be established at temperatures between 725 and 850° F. and may require residence times between 15 minutes and four hours. Further control of thermal conditions may be established according to the specific characteristics of the MPW feedstock.

Compounds which are volatile under the selected operating conditions will exit the thermal conversion unit, 60, as the overhead fraction, stream 61. A sophisticated multiple stage recovery system, 70, may be employed to recover the overhead material, stream 61. Singular or multiple condensing units may be required to sufficiently reduce the temperature of the overhead fraction, stream 61, so that the vapor will be converted into a liquid or solid phase. Condensing units which may be employed for this recovery may take the form of standard tube and shell, cyclone, or any other suitable heat exchanger design. Condensed liquid overhead material, stream 71, shall be captured and stored in an overhead collection vessel, 80. Overhead material which is non-condensable, stream 82, may be comprised of hazardous or environmentally restricted vapors, and may require additional scrubbing using established methods before utilization as a fuel gas, flared, or vented to atmosphere. Liquid overhead material may be stored and buffered, 80, until further processing is required, or the material is added into the final blended low sulfur marine fuel product, stream 81. Notably, near ambient conditions may be utilized.

Compounds which are not volatile under the selected operating conditions exit the thermal conversion unit, 60, as the bottom fraction, stream 62. A traditional heat transfer unit may be required to reduce the temperature of the bottoms fraction, stream 62, before entering the liquid-solid separation unit, 90. Phase separation units for the liquid-solid separation unit, 90, may include a settling tank, cyclone, or other similar unit which has been designed to separate materials based on physical properties. To enhance the separation of physical phases and the recovery of liquid fraction, stream 91, it may be necessary to introduce condensed liquid overhead fraction, stream 83, to the liquid-solid separation unit, 90. Separation may be accomplished at moderate temperatures within the range of ambient to 450° F. Residence times will vary, as settling time may vary significantly depending on the type of processing vessel selected, and MPW composition.

Solids recovered from the separation unit, 90, shall be transferred, stream 93, to a recovered solids holding tank, 100, and may be comprised of char (coke), or any additional unreacted MPW components including inert, or inorganic materials, all of which are undesirable in the final blended low sulfur marine fuel product. The recovered solids tank may require temperature within the range of ambient to 250° F. Although recovered solids are undesirable in the intended final blended low sulfur marine fuel product of the SPER process, the solids may serve as a potential combustion source for heating the process, other areas of the marine vessel, and/or be applicable in other industrial sectors.

Recovered liquid, stream 91, from the solid-liquid separator, 90, shall be combined in-line with condensed overhead, stream 81, to reduce the viscosity of the resultant stream, stream 92, which is the final blended low sulfur marine fuel product. The final blended low sulfur marine fuel product may be stored, 110, at conditions which favor a stable product. Stability is ideally achieved at temperatures between ambient and 250° F. The final blended low sulfur marine fuel product may also be transferred directly to the fuel reserve of the marine vessel in an effort to be self-fueling, or may be offloaded if environmentally favorable. The blended low sulfur marine fuel product is value added because of the incorporated lower molecular weight components generated from the thermal conversion, and is intended to fall within the range of No. 4, No. 5, or No. 6, or similar fuel oil. Specific fuel oil ranges shall be established by the selection of oil medium co-processing agent characteristics.

In one embodiment, the process may utilize an indiscriminately sized feed stream composed of MPW acquired from an external company tasked with oceanic remediation. The MPW will be onloaded to the SPER processing vessel, and may be comprised of, but not limited to, PE, PP, PS, PET, and PVC, lesser amounts of PUR, PP&A, and less than 30 percent impurities, such as paper labels, algae, residual food, or crustaceous organisms. Bulk MPW may be subjected to non-intensive water reduction to free a majority of the excess water from the MPW. MPW will then be reduced to a particle size of less than five inches by mechanical size reduction. Reduced size plastic particles will be subjected to additional drying during the storage phase. Dried plastic particles are continuously fed to a mixing tank, and are combined with a selected oil medium to obtain a semi-uniform feed stream for the thermal conversion unit. The feed stream will undergo pyrolysis in the thermal conversion unit to initiate thermal degradation to yield lower molecular weight liquid products, along with resulting char (coke) and gas streams. Pyrolytic conditions will be established at near atmospheric pressure, under an inert atmosphere, at a temperature between 725-850° F., with a residence time of less than 90 minutes. Produced overhead and bottoms fractions will be combined in ratios sufficient to obtain a blended low sulfur marine fuel oil. Additional co-products from this reaction may be recovered from the overhead stream, and may include: hydrochloric, benzoic, and terephthalic acids which may be stored for utilization by other industries. Characteristics of the final low sulfur liquid marine fuel product may vary slightly according to the incoming distribution of plastic polymers in the feedstock MPW.

### REFERENCES CORRESPONDING TO EXAMPLE 4

“ Bakelite: First Synthetic Plastic” American Chemical Society National Historic Chemical Landmark

Eriksen, Marcus, et al. “Plastic Pollution in the World's Oceans: More than 5 Trillion Plastic Pieces Weighing over 250,000 Tons Afloat at Sea.” PLOS ONE, Public Library of Science.

Geyer, R., J. R. Jambeck, K. L. Law, 2017, “Production, Use and Fate of all Plastics Ever Made”, Sci. Adv. 2017, 19 Jul. 2017.

Guffey, F. D. and F. A Barbour, 1992, “Recycling Waste Plastics by Thermal Decomposition”, Western Research Institute Report of Investigations, WRI-92-M008, Laramie, Wyo.

“The History and Future of Plastics.” Science History Institute, 20 Dec. 2016,

Jambeck, Jenna R., et. al, 2015, “Plastic Waste Inputs from Land into the Ocean”, Science, American Association for the Advancement of Science, February 2015.

Savage, Phillip E., 2000, “Mechanisms and Kinetics Models for Hydrocarbon Pyrolysis”, Journal of Analytical and Applied Pyrolysis, 54 pp. 109-126.

Sharuddin, S. D. A., F. Abnisa, W. M. A. W. Daud, M. K. Aroua, 2016, “A Review of Pyrolysis of Waste Plastics”, Energy Conservation and Management, 115, pp. 308-326.

Sheavly, S. B., and K. M. Register, 2007, “Marine Debris & Plastics: Environmental Concerns, Sources, Impacts and Solutions”, SpringerLink, Springer US.

“Sulphur 2020— cutting sulphur oxide emissions”, 2019, International Maritime Organization.

Themelis, N. J., M. J. Castaldi, J. Bhatti, and L. Arsova, 2011, “Energy and Economic Value of Non-recycled Plastics (NRP) and Municipal Solid Wastes (MSW) That are Currently Landfilled in the Fifty States”, EEC Study of Non-Recycled Plastics—August 2011, Earth Engineering Center, Columbia University.

US Environmental Protection Agency, 2018, Advancing Sustainable Materials Management: 2015 Fact Sheet, EPA Report No. 530-F-18-004.

US Environmental Protection Agency, 2019a, Energy Recovery from the Combustion of Municipal Solid Waste (MSW).

US Environmental Protection Agency, 2019b, Plastics: Material-Specific Data.

Waste360 Staff, 2019, “Report: U.S. Sent 157,000 Shipping Containers of Plastic Waste to Other Countries in 2018.” Waste360, 12 Mar. 2019.

### EXAMPLE 5

### Petroleum Oils as a Liquid Blending Agent

A series of experiments was conducted with petroleum oils as the liquid blending agent. The residual fraction, toluene insoluble fraction, and qualitative blend compatibility tests were used as a measure of the conversion achieved via the exemplary process. A lower residual fraction (ASTM D7169), lower toluene insoluble fraction (ASTM D893), and lower qualitative blend compatibility rating (ASTM D4740) indicates higher conversion. Products with a high residual fraction, or a high toluene insoluble fraction are indicative of unreacted or partially reacted, solid, feedstock, or coke/char. The qualitative blend compatibility rating test is used as a measure of product stability, which therefore measures a fuels propensity to separate. Heterogeneous products, like those which have achieved no, or partial conversion, will have a higher rating. Increased gas production, or naphtha fractions also indicate higher levels of cracking reactions, and therefore have higher conversions.

All product data is represented as the combined overhead+bottoms products, which were not separated and recombined during the batch experiments. The polymer blend used in the experiments had the following composition: 51 wt. % low density polyethylene (LDPE), 9 wt. % polypropylene (PP), 33 wt. % polystyrene (PS), and 7 wt. % high density polyethylene (HDPE).

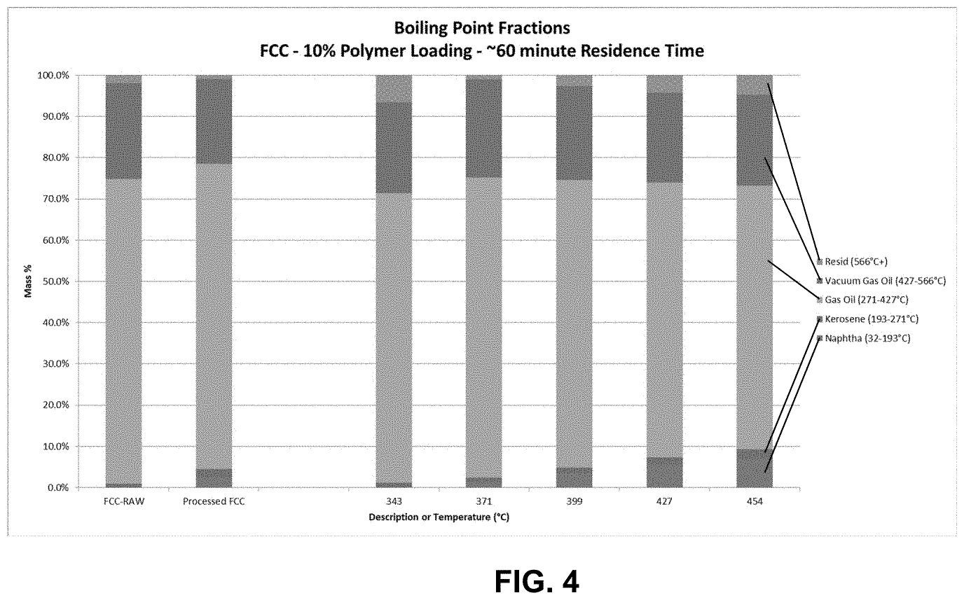

Turning now to FIGS. 4-10, the data labeled “FCC-RAW” corresponds to raw unreacted fluidized catalytic cracker slurry oil, an aromatic feedstock and gasoline precursor. The data labeled “Processed FCC” corresponds to the reacted fluidized catalytic cracker slurry oil without the presence of any polymer. The data labeled “HYC-RAW” corresponds to raw unreacted hydrocracker feedstock, a paraffinic feedstock and diesel precursor. The data labeled “Processed HYC” corresponds to reacted hydrocracker feedstock.

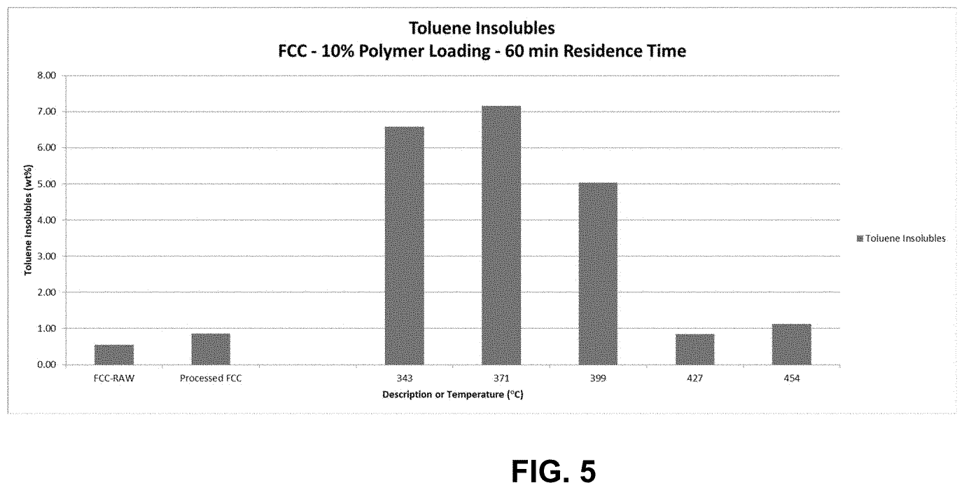

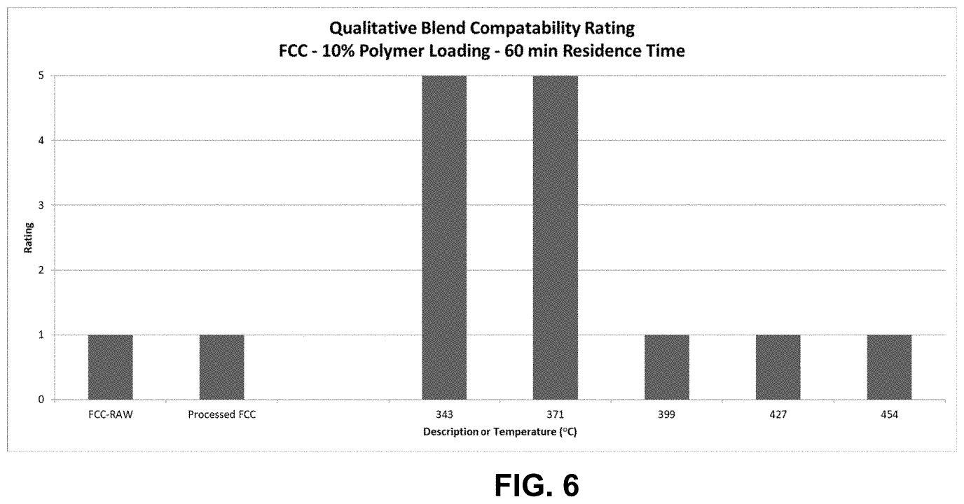

Turning to FIGS. 4-6, the resultant boiling point fractions (FIG. 4), toluene insoluble fractions (FIG. 5), and blend compatibility ratings (FIG. 6) of the pyrolysis co-processing product are shown over varying pyrolysis temperatures from 343 to 454° C. (650-850° F.), with a 60 minute residence time and 10% total polymer loading in a liquid blending agent of fluidized catalytic cracker slurry oil. For comparison, the properties of the pure (no polymer) liquid blending agents “FCC-RAW” (unreacted fluidized catalytic cracker slurry oil) and “Processed FCC” corresponds to the (reacted fluidized catalytic cracker slurry oil) are shown in the leftmost columns. As can be seen in FIG. 5, the toluene insoluble fraction sharply decreases (and conversely the thermochemical conversion of the polymers and the liquid blending agent increases) starting around 399° C. through 454° C. (750 and 850° F.). Thus, the pyrolytic co-processing of the polymers and the liquid blending agent showed particular efficacy in the temperature range of about 399 to 454° C. (750 to 850° F.). Below this temperature range, conversion seemed to be fairly minimal. Surprisingly, above about 427° C. (800° F.), the toluene insoluble fraction increased slightly as coking reactions were initiated.

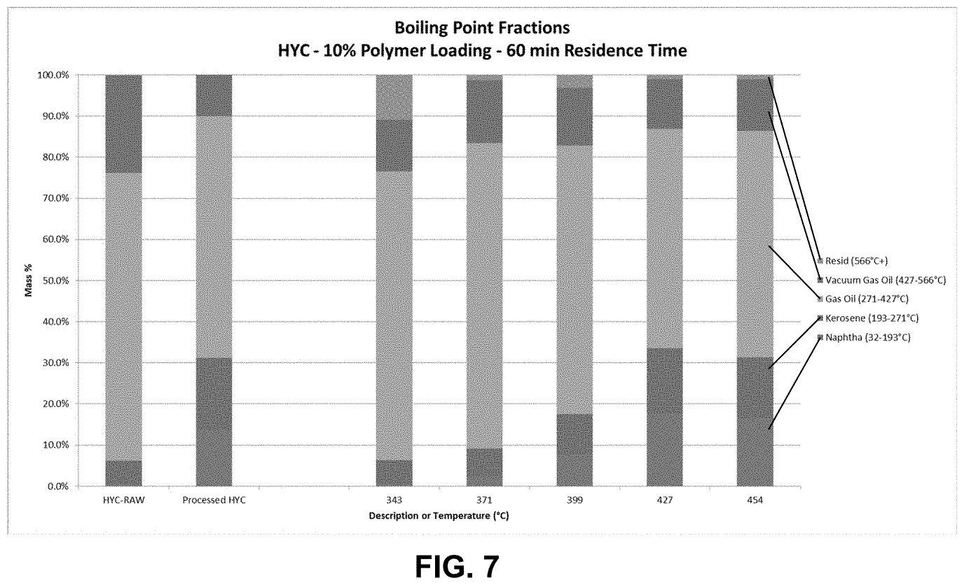

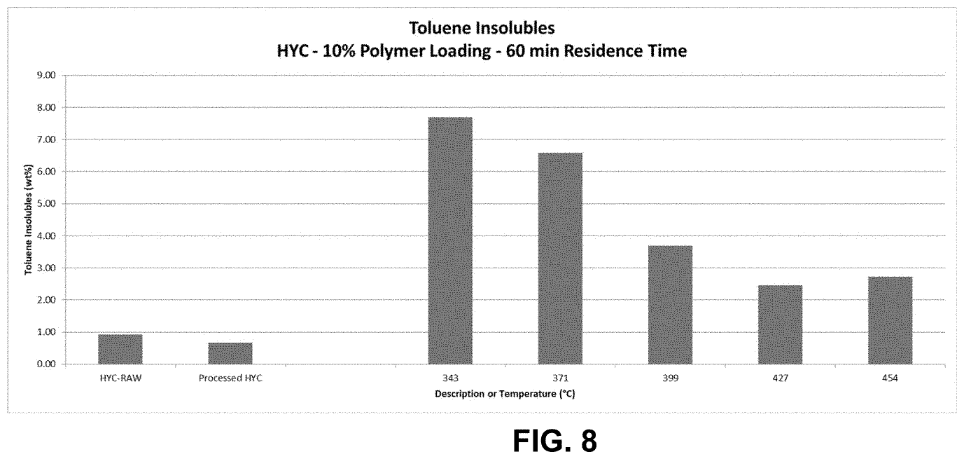

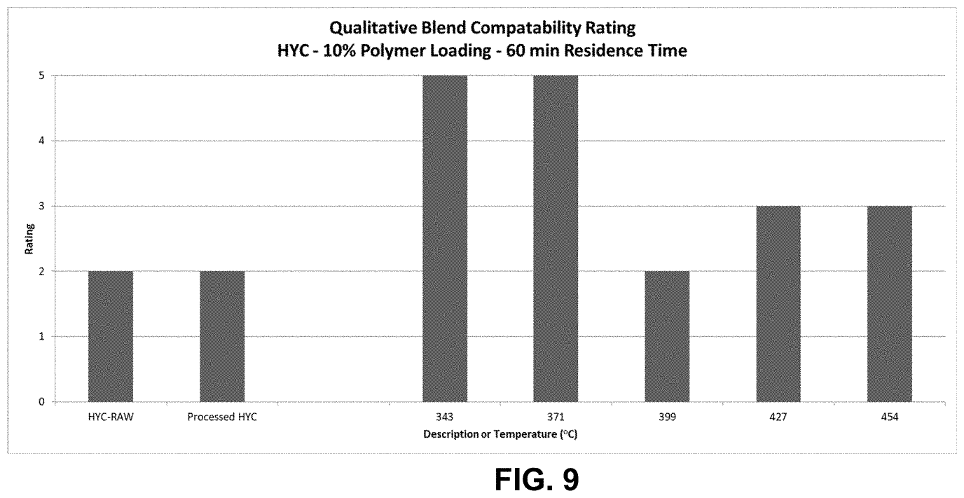

Turning to FIGS. 7-9, the resultant boiling point fractions (FIG. 7) toluene insoluble fractions (FIG. 8) and blend compatibility ratings (FIG. 9) of the pyrolysis co-processing product are shown over varying pyrolysis temperatures from 343 to 454° C. (650-850° F.), with a 60 minute residence time and 10% total polymer loading in a liquid blending agent of reacted hydrocracker feedstock. For comparison, the properties of the pure (no polymer) liquid blending agents “HYC-RAW” (unreacted hydrocracker feedstock) and “Processed HYC” are shown in the leftmost columns. As can be seen in FIG. 8, the toluene insoluble fraction decreases (and conversely the thermochemical conversion of the polymers and the liquid blending agent increases) starting around 399° C. through 454° C. (750 to 850° F.).

Thus, the pyrolytic co-processing of the polymers and the liquid blending agent showed particular efficacy in the temperature range of about 399 to 454° C. (750 to 850° F.). Below this temperature range, conversion seemed to be fairly minimal. Surprisingly, above about 825° F., the toluene insoluble fraction increased slightly as coking reactions were initiated. With increasing reaction temperature, the contribution of toluene insolubles decreased, and so did the blend compatibility ratings, which indicates higher conversions, particularly above 399° C. (750° F.). Higher contributions of naphtha and kerosene fractions for the HYC oil medium products indicate higher levels of cracking as compared to the FCC oil medium.

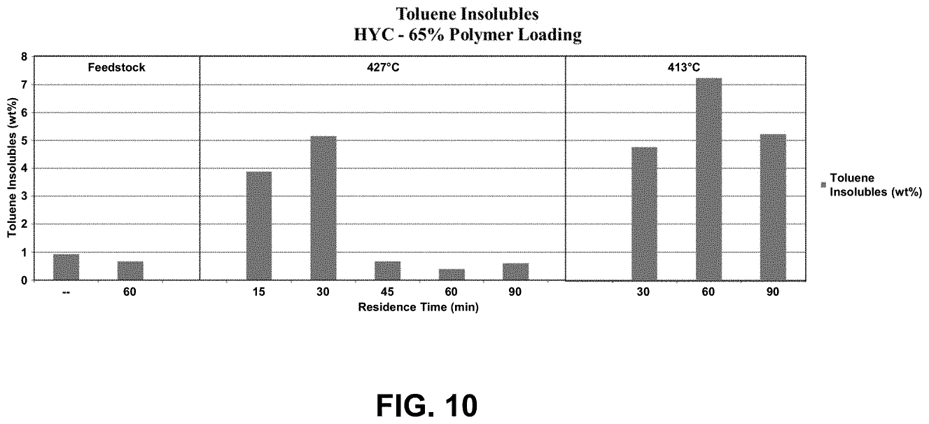

Turning now to FIG. 10, residence time was varied for pyrolysis co-processing of the polymers and the reacted hydrocracker feedstock at pyrolysis temperatures of 413° C. and 427° C. (775 and 800° F.). At the preferred temperature of 427° C. (800° F.), the toluene insoluble fraction decreased sharply after 30 minutes and rose slightly at 90 minutes. Higher conversions were achieved at 427° C. (800° F.) as compared to 413° C. (775° F.). At lower residence times (15 or 30 minutes), lower conversion of the polymers was achieved as indicated by higher toluene insoluble fraction and higher residual fractions.

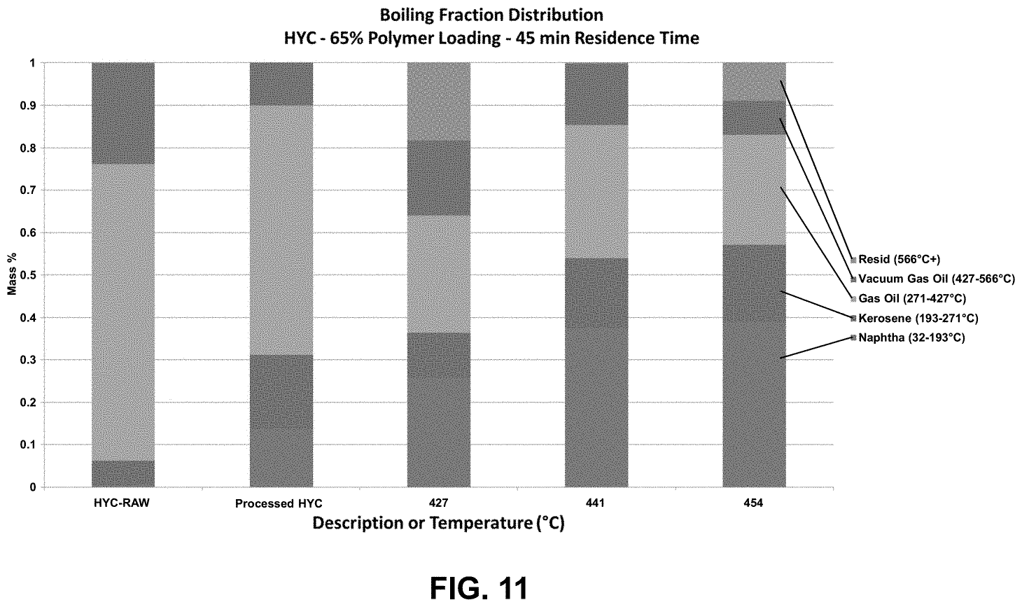

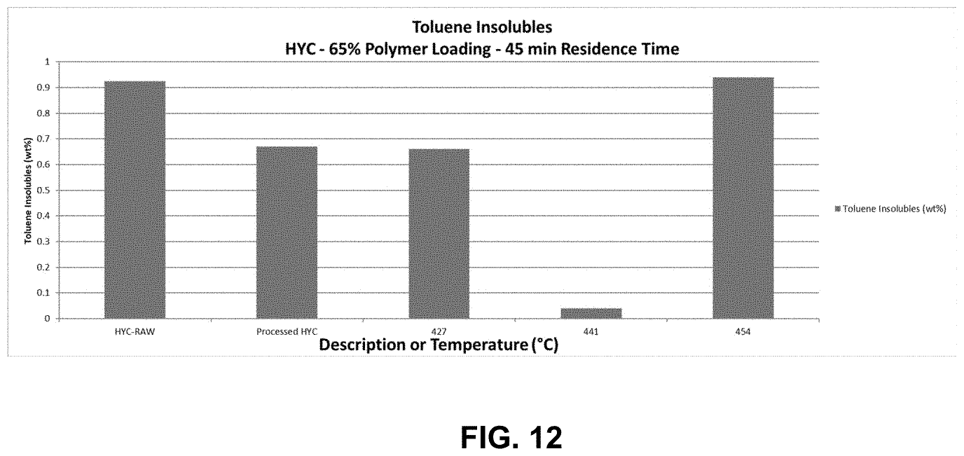

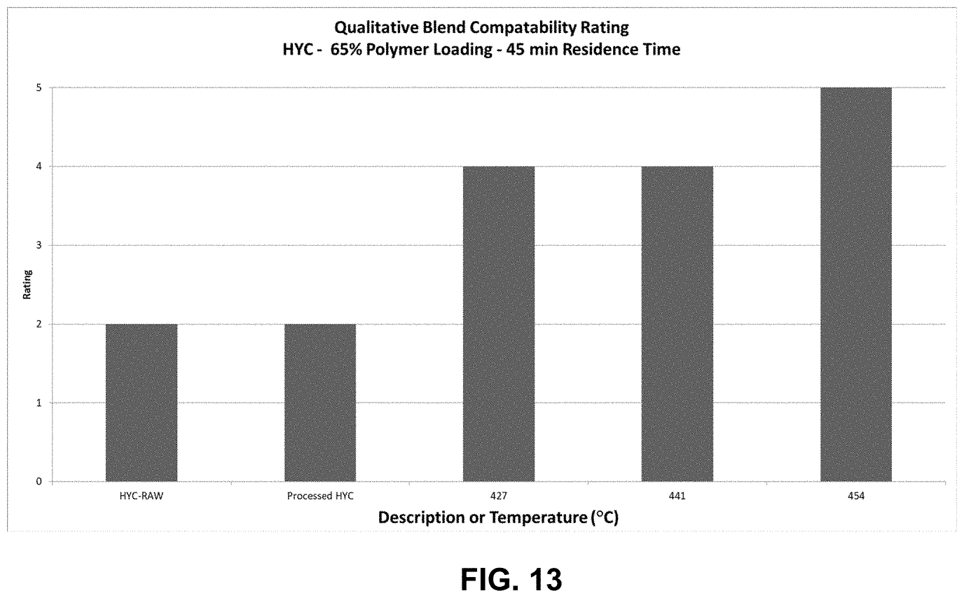

Turning now to FIGS. 11-13, the resultant boiling point fractions (FIG. 11) toluene insoluble fractions (FIG. 12) and blend compatibility ratings (FIG. 13) of the pyrolysis co-processing products are shown over varying pyrolysis temperatures from 427 to 454° C. (800-850° F.), with a 45 minute residence time and 65% total polymer loading in liquid blending agent of hydrocracker feedstock. It was determined that 825° F. was a more favorable reaction temperature to process the higher 65 percent polymer loading in the hydrocracker feedstock liquid blending agent, according to lower toluene insoluble fraction and lower residual fractions.

### EXAMPLE 6

### Renewable Oil as a Liquid Blending Agent

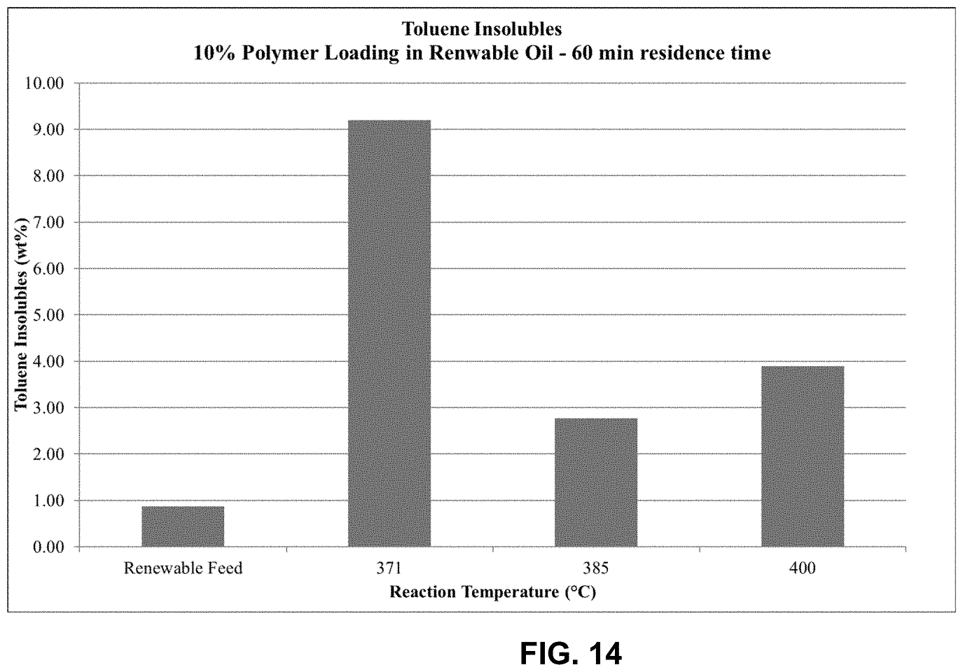

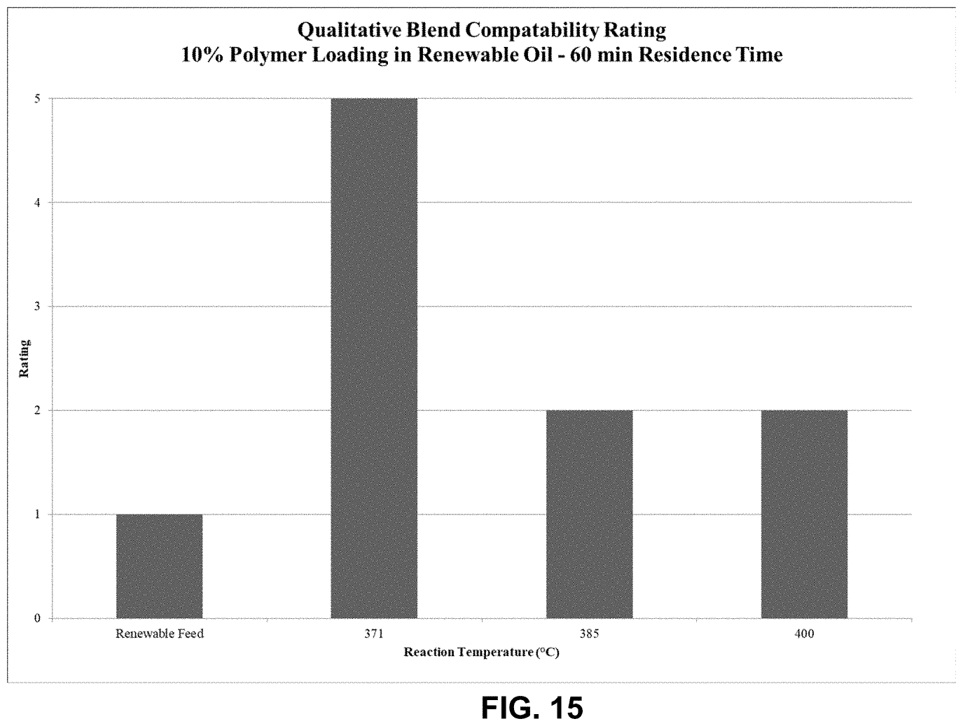

Turning now to FIGS. 14-15 the data labeled “Renewable Feed” corresponds to raw unreacted renewable feedstock. For comparison, the properties of the pure (no polymer) liquid blending agents “Renewable Feed” (unreacted renewable feedstock) are shown in the leftmost columns.

The resultant toluene insoluble fractions (FIG. 14) and blend compatibility ratings (FIG. 15) of the pyrolysis co-processing products are shown over varying pyrolysis temperatures from 371 to 400° C. (700-750° F.), with a 60 minute residence time and 10% total polymer loading in a renewable liquid blending agent.

All product data is represented as the combined overhead +bottoms products, which were not separated and recombined during the batch experiments. The polymer blend used was: −85 wt. % low density polyethylene (LDPE), 15 wt. % polypropylene (PP). It was observed that over varying pyrolysis temperatures from 371 to 399° C. (700-750° F.), that a pyrolysis temperature of at least 725° F. was needed to achieve sufficient conversion of the polymers, according to lower toluene insoluble fractions and more stable blend compatibility ratings. It was also determined that a 75 minute residence time was a more favorable residence time due to a lower toluene insoluble fraction and more stable blend compatibility rating.

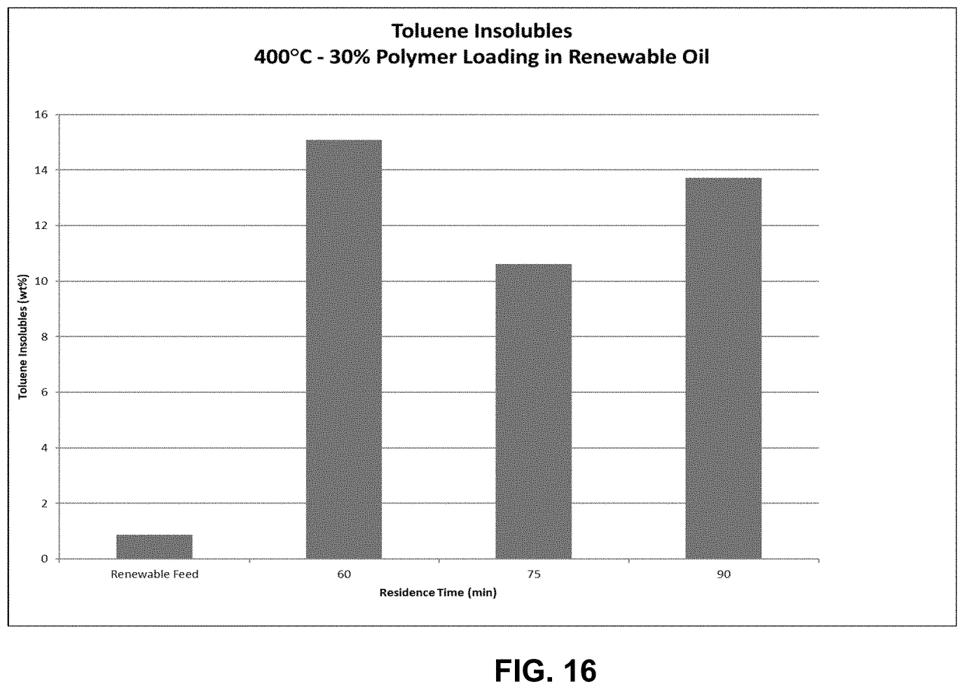

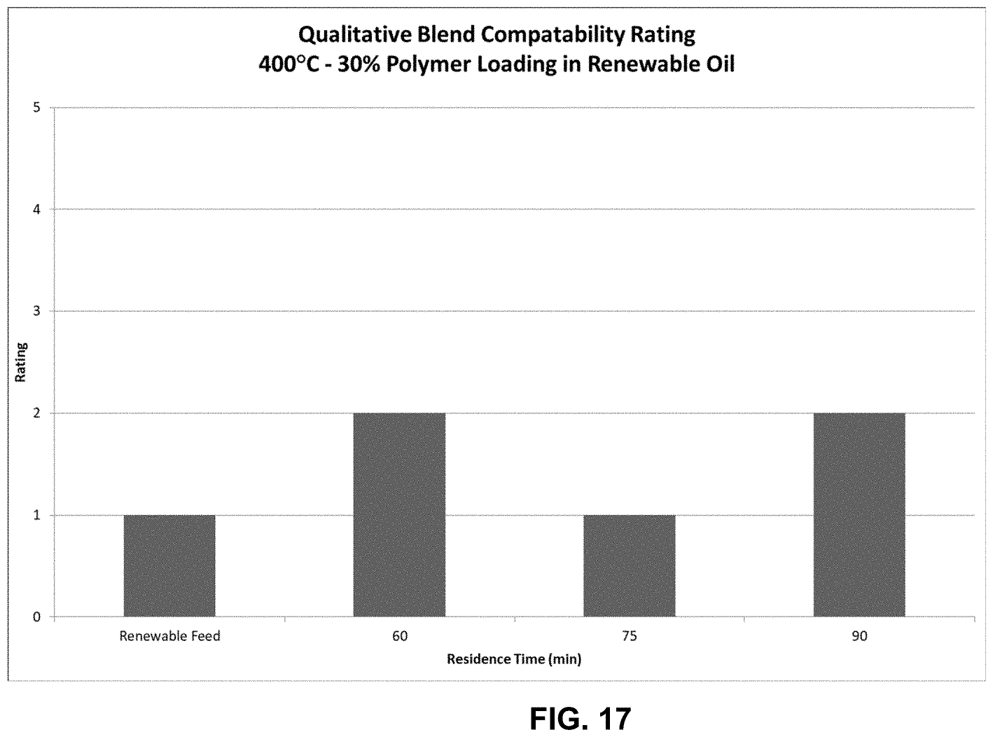

Turning now to FIGS. 16-17, residence time was varied for pyrolysis co-processing of the polymers and the renewable liquid blending agent at a pyrolysis temperature of 400° C. (750° F.) and 30 percent polymer loading. As can be seen in FIG. 16, the toluene insoluble fraction decreases (and conversely the thermochemical conversion of the polymers and the liquid blending agent increases) after 60 minutes. While lower conversion was achieved, the products would make great candidates for hydroprocessing because of their relatively low propensity to separate according to low qualitative blend compatibility ratings (FIG. 17).

### EXAMPLE 7

### Polymer Processing without a Liquid Blending Agent

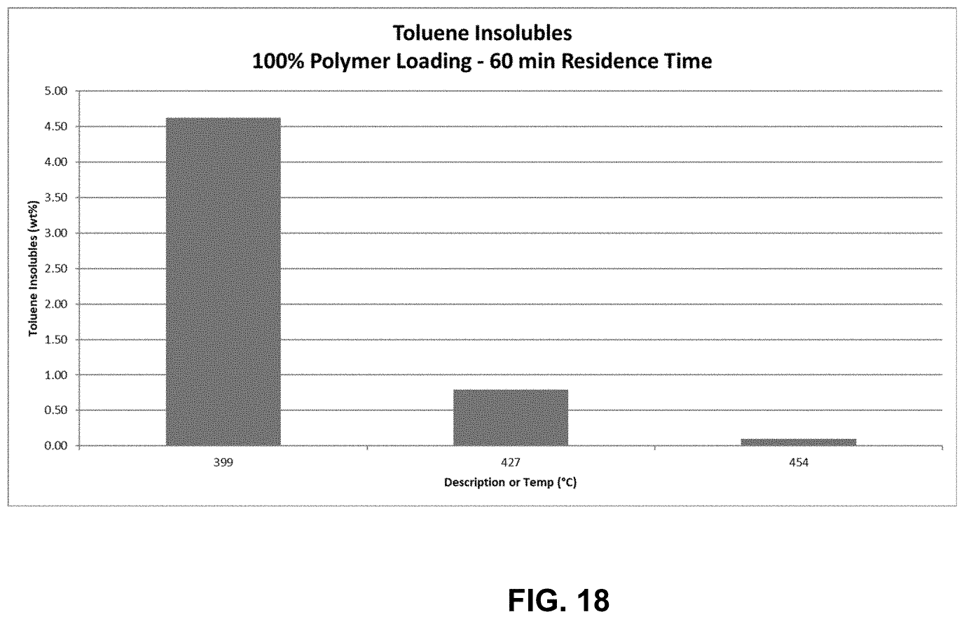

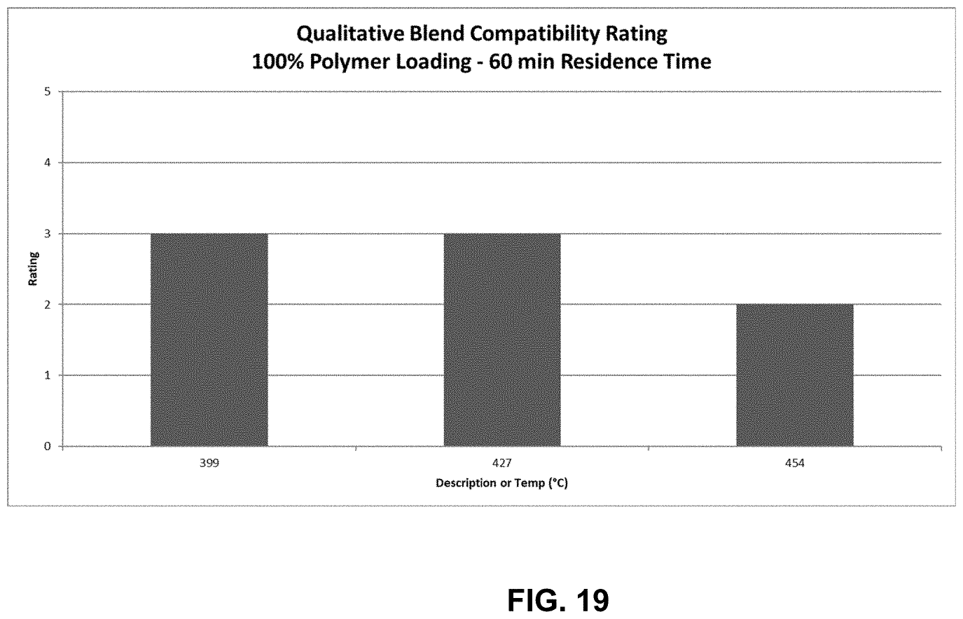

Turning now to FIGS. 18-19 the resultant toluene insoluble fractions (FIG. 18) and blend compatibility ratings (FIG. 19) of the pyrolysis co-processing products are shown over varying pyrolysis temperatures from 399 to 454° C. (750-850° F.), with a 60 minute residence time and 100% total polymer loading are shown.

All product data is represented as the combined overhead+bottoms products, which were not separated and recombined during the batch experiments. The polymer blend used in the experiments had the following composition: 51 wt. % low-density polyethylene (LDPE), 9 wt. % polypropylene (PP), 33 wt. % polystyrene (PS), and 7 wt. % high-density polyethylene (HDPE).

As shown in FIG. 18, as the temperature of the of the pyrolysis was increased from 399 to 427° C. (750-850° F.), the toluene insoluble fraction dropped by a factor of six from approximately 4.6 wt. % to approximately 0.75 wt. %. A further reduction to approximately 0.1% was achieved as the temperature was increased to 454° C. (850° F.). from over varying pyrolysis temperatures from 399 to 454° C. (750-850° F.), a temperature of at least 750° F. was able to achieve reasonable conversion of the polymers according to low toluene insoluble fractions and blend compatibility ratings. However, even higher conversion was achieved at a pyrolysis temperature of at least 800° F., as indicated by toluene insoluble fractions of less than 1 weight percent.

### Statements Regarding Incorporation by Reference and Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Every device, system, formulation, combination of components, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method for processing polymeric waste materials into one or more products, the method comprising:
pyrolyzing a solid polymeric waste material, wherein the pyrolyzing comprises:
heating the solid polymeric waste material in the absence of oxygen to a temperature of 725° F. to 850° F. for a duration of 15 to 90 minutes; and
thermochemically converting, in response to the heating step, at least some of the solid polymeric waste material into a first liquid product;
separating the first liquid product from residual solids;
separating a vapor stream from the vessel; and
condensing at least a portion of the vapor stream into a second liquid product.

2. The method of claim 1 comprising:
prior to the pyrolyzing step, contacting the solid polymeric waste material with a liquid blending agent to form a mixture.

3. The method of claim 2 wherein the pyrolyzing step comprises:
heating the mixture in the absence of oxygen to a temperature of 725° F. to 850° F. for a duration of 15 to 90 minutes; and
thermochemically converting, in response to the heating step, at least some of the liquid blending agent and the at least some of the solid polymeric waste material into the first liquid product.

4. The method of claim 1 comprising contacting the first liquid product with the second liquid product to form a combined liquid product.

5. The method of claim 1 comprising:
separating, prior to the contacting step, the solid polymeric waste material into at least two fractionated polymeric waste streams.

6. The method of claim 5 wherein the at least two fractionated polymeric waste streams comprise a low-density polyethylene (LDPE) stream and a polypropylene (PP) stream.

7. The method of claim 2, wherein the liquid blending agent comprises a petroleum or petroleum derived material, a renewable or renewable derived material, marine fuel, a petroleum residue, a hydrogen donor oil, a low value oil, heavy oil, a refinery or petrochemical intermediate stream, solvent, or any combination thereof.

8. The method of claim 1, wherein the solid polymeric waste comprises polyethylene (PE), polypropylene (PP), polystyrene (PS), polyethylene terephthalate (PET), polyvinyl chloride (PVC), polyurethane resins (PUR), polyester, polyamide, acrylic (PP&A) fibers, or any combination thereof.

9. The method of claim 1, wherein at least 50% by weight of the liquid blending agent has a boiling point within the range of 520° F. to 1050° F.

10. The method of claim 1 comprising preheating the mixture to a temperature of 450 to 925° F. prior to introduction into the thermal conversion reactor.

11. The method of claim 1, wherein the solid polymeric waste material comprises not greater than 30 wt. % non-polymeric material.

12. The method of claim 1, wherein the non-polymeric material comprises paper, dirt, organics, glass, foodstuffs, textiles, metal or any combination thereof.

13. The method of claim 1, wherein the paper products comprise newsprint, corrugated cardboard, Kraft paper, mixed paper, boxboard, and/or compostable paper.

14. The method of claim 1, wherein the solid polymeric waste material comprises not greater than 50 wt. % paper products.

15. The method of claim 1 comprising drying the solid polymeric waste material prior to the blending step.

16. The method of claim 1, wherein the solid polymeric waste material comprises not greater than 2.5 wt. % moisture.

17. The method of claim 1, comprising mechanically reducing an average particle size of the solid polymeric waste material prior to the blending step.

18. The method of claim 16, wherein the average particle size is from 0.25 to 2 inches.

19. The method of claim 1, wherein transferring the mixture to the thermal conversion reactor comprises pumping the mixture to the thermal conversion reactor.

20. The method of claim 1 comprising:
selecting the condensed vapor, the thermally converted liquids, the blended liquid product, or a combination thereof as a hydroprocessing feedstock;
transferring the hydroprocessing feedstock to a catalyst bed;
contacting the hydroprocessing feedstock with a catalyst of the catalyst bed; and
converting the hydroprocessing feedstock into an upgraded liquid product.

21. The method of claim 20, wherein the step of contacting the hydroprocessing feedstock with the catalyst occurs at a temperature of 500-950° F.

22. The method of claim 20, wherein the hydroprocessing feedstock further comprises an unprocessed liquid blending agent stream.

23. The method of claim 1 comprising:
transferring the residual solids to a solids storage vessel;
collecting an effluent stream from the solids storage vessel;
condensing the effluent stream from the solids storage vessel into a residual liquid recovery stream; and
combining the residual liquid recovery stream with the blended liquid product.

24. The method of claim 1 comprising:
fractionating, separating, and/or recovering the vapor stream from the vessel.

25. The method of claim 24, wherein the fractionating, separating, and/or recovering comprises condensing and collecting liquid and solid phase acid products.

26. The method of claim 24, wherein the fractionating, separating, and/or recovering comprises separating condensable components from the vapor stream.

27. The method of claim 26, wherein the fractionating, separating, and/or recovering comprises separating benzene, toluene, ethylbenzene, and/or xylenes from the vapor stream.

28. The method of claim 24, wherein the fractionating, separating, and/or recovering comprises separating the vapor stream into a condensable fraction and an uncondensable fraction.

29. The method of claim 28 comprising separating the condensable fraction into simplified fractions.

30. The method of claim 28 comprising separating the condensable fraction into boiling fractions or compound classes.

31. The method of claim 28 comprising separating the uncondensable vapor stream into simplified fractions.

32. The method of claim 28 comprising fractionating the uncondensable vapor stream into an ethylene fraction and/or a propylene fraction.

33. The method of claim 1 comprising:
recycling or recirculating the first liquid product, or fraction thereof, back to the thermal conversion reactor for additional pyrolytic conversion.

34. The method of claim 1 wherein the first liquid product is an asphalt material or additive.

35. The method of claim 1 wherein the pyrolyzing step comprises heating the mixture in the absence of oxygen to a temperature of 750° F. to 850° F.

36. The method of claim 1 wherein the pyrolyzing step has a duration of 30 to 90 minutes.
